(19) United States
(12) Patent Application Publication
(10) Pub. No.: US 2025/0362996 A1
(43) Pub. Date: Nov. 27, 2025

(54) SYSTEMS AND METHODS FOR LINE-BASED ERROR DETECTION

(71) Applicant: Shelfmark, Inc., Pittsburgh, PA (US)

(72) Inventors: Shreyas Piplani, Pittsburgh, PA (US); Patrick O'Donnell, Pittsburgh, PA (US)

(21) Appl. No.: 19/217,446

(22) Filed: May 23, 2025

Related U.S. Application Data
(60) Provisional application No. 63/651,528, filed on May 24, 2024.
(60) Provisional application No. 63/694,361, filed on Sep. 13, 2024.

(51) Int. Cl. G06F 11/07

(52) U.S. Cl. CPC G06F 11/079; G06F 11/0733

(57) ABSTRACT

Systems and techniques may generally be used for error detection in an image. An example technique may include identifying a set of training images, the set of training images representing respective products on a conveyance line, the respective products being printed on before coming off the conveyance line, and labeling the set of training images with an indication of whether a product in an image in the set of training images includes a printing defect or does not including a printing defect. The example technique may include training a machine learning model using the set of training images, and outputting the machine learning model to identify printing errors on the conveyance line.

### CLAIM OF PRIORITY

This application claims the benefit of priority to U.S. Provisional Applications Nos. 63/651,528, filed May 24, 2024, titled “Systems and Methods for Print Quality Control Systems and Methods for Print Quality Control”; and 63/694,361, filed Sep. 13, 2024, titled “Direct to Print Quality Control System and Methods”, each of which is hereby incorporated herein by reference in its entirety.

### BACKGROUND

Line-based printing includes applying ink or pigment in precise patterns onto various substrates. This technique can be adapted for diverse materials including wood, textiles, paper, and other consumer goods through adjustments in printing pressure, ink formulation, and application methods. Modern line-based printing systems use digital controls to ensure consistent reproduction across production batches while maintaining high resolution even on textured surfaces. The ability to precisely control line thickness, spacing, and overlap makes this printing method particularly valuable for creating intricate designs, text, and imagery on commercial and custom products. However, like any industrial process, line-based printing is subject to errors, which may be costly and difficult to detect.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a block diagram illustrating a system for error detection in an image in accordance with some examples.

FIG. 2 illustrates a block diagram showing training of a deep learning model for error detection in an image in accordance with some examples.

FIG. 3 illustrates a block diagram showing inferencing with a deep learning model for error detection in an image in accordance with some examples.

FIG. 4 illustrates a machine learning engine for training and execution related to error detection in an image in accordance with some examples.

FIG. 5 illustrates a flowchart showing a technique for training a deep learning model for error detection in an image in accordance with some examples.

FIG. 6 illustrates a flowchart showing a technique for inferencing using a deep learning model for error detection in an image in accordance with some examples.

FIG. 7 illustrates generally an example of a block diagram of a machine upon which any one or more of the techniques discussed herein may perform in accordance with some examples.

### DETAILED DESCRIPTION

The systems and techniques described herein provide for using artificial intelligence and computer vision to automate line-based visual inspection across a wide range of manufacturing products. In an example, a system includes a sequence of steps, each of which may be used independently or in combination, to detect, localize, or assess a defect in a manufactured product, such as without using a predefined threshold or a reference to a defect free product. For example, a captured image of a product may be processed using computer vision techniques to enhance visual features indicative of potential defects. These processed images may be analyzed by a trained model to identify or localize any one or more common visual defects specific to a product. The systems and techniques may be used modularly, allowing for any combination or permutation of elements or components to be tailored for visual inspection needs of various line-based manufacturing applications.

An important part of quality control in a production process for a line-based product printing or assembly is visual inspection. Visual inspection is used to ensure that products are free from defects before moving to a final processing or shipment stage. Traditionally, this inspection has been performed manually, which is both labor-intensive and susceptible to human error. Errors may lead to defective products advancing to later stages of production, ultimately resulting in costly rework, recalls, or customer dissatisfaction.

Previous automated approaches have attempted to address these challenges by employing conventional image processing techniques such as template matching, image similarity computation, etc., which involve comparing every instance of a product coming out of a line to a defect free reference image. However, these solutions are often resource-intensive, unreliable due to environmental conditions, difficult to generalize across different product types, or dependent on reference templates that may not always be available.

The present systems and techniques solve the problems of both manual visual inspection and previous approaches, and improve computing-based approaches to provide a technical solution including using an image enhancement technique and using a deep learning-based defect recognition model. The hybrid approach provided by the present systems and techniques includes providing direct detection and localization of defects from image data while eliminating or reducing use of or downsides of existing approaches. For example, the present systems and techniques do not require predefined image comparison thresholds or metrics, or reference images specific to a particular product type. The systems and techniques are designed to be modular and adaptable, allowing any combination or permutation of elements to be used in a visual inspection process across a wide range of manufacturing applications.

The present systems and techniques provide for line-based visual inspection for use in any of a wide range of manufacturing facilities, with automated detection and visualization of defects on the manufactured product. Several components are described herein that may be used independently or in combination to identify the presence and position of a visual defect in a product.

In some examples, after capturing a uniformly illuminated, noise-free, and clearly visible image of a product instance in-line, a computer vision technique may be used, if applicable depending on the type of product, to enhance image features. A technique may be used in particular when features related to defects, if present, on the product benefit from enhancement. Enhancing features may include performing contrast adjustment, image filtering, feature extraction, or noise reduction. The enhancements may help reveal subtle or small-scale defects that may not be visible in a raw image.

Based on whether enhancements are applied to an image, a raw or an enhanced image may be passed as input to a deep learning-based detection model to detect whether the image includes a defect. The model may be trained to distinguish common defect patterns from design elements or other non-relevant features based on a type of product that is manufactured (and present in an image). The model may return regions of interest, for example defined by bounding geometries or coordinates, which correspond to a presence of a visual anomaly on a product in an image. In some examples, detection data may be overlaid on a corresponding image for display. Results may be displayed on a mobile or web application to enable real-time feedback or actionable insights for an operator.

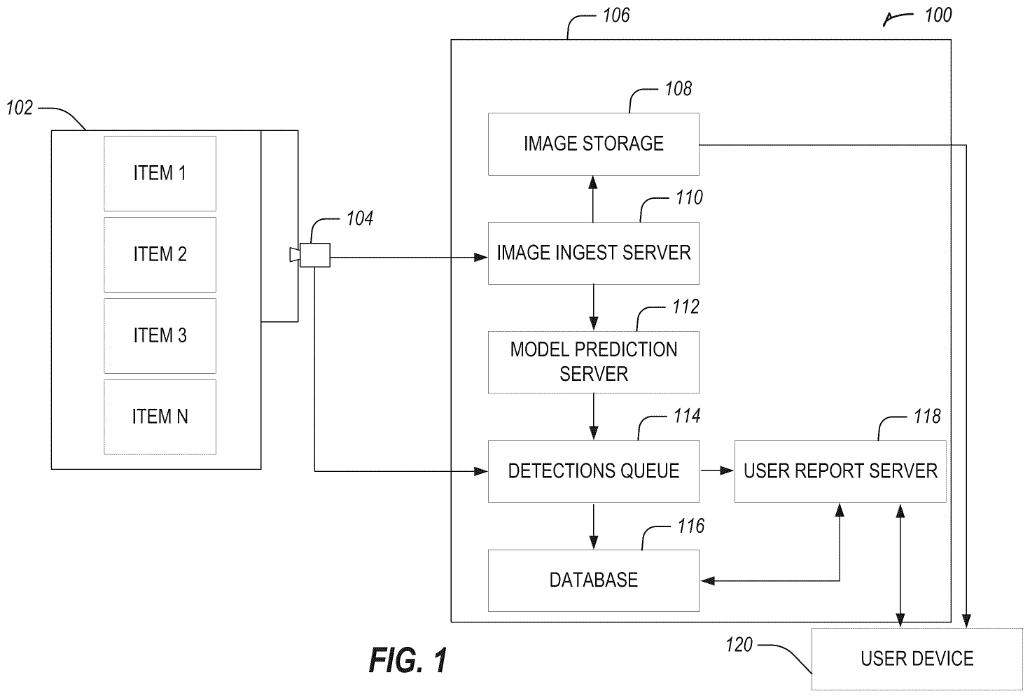

FIG. 1 illustrates a block diagram 100 illustrating a system 106 for error detection in an image in accordance with some examples. The block diagram 100 includes a conveyance line 102, including a series of items (e.g., item 1, item 2, item 3, item n, etc.). A camera 104 may be used to capture each item in the series of items and send an image of an item to an image ingest server 110 of the system 106. The image ingest server 110 may send an image to image storage 108, for example for retrieval by a user device or a model. The image ingest server 110 may send an image to a model prediction server 112, which may run a trained model to determine whether a defect is present in the image. The model prediction server 112 may send information corresponding to a defect to a detections queue 114, which may output information for storage at a database 116 or to a user report server 118. The user report server 118 may communicate with the database 116. The user report server 118 may send an indication of a defect or no defect regarding a particular product to a user device 120. The system 106 may include the image ingest server 110, the image storage 108, the model prediction server 112, the detections queue 114, the database 116, or the user report server 118. Although described as separate servers, a database, and storage, any of the components 108, 110, 112, 114, 116, or 118 may be combined, separated from the system 106 (e.g., remote to the system 106), or omitted. For example, the system 106 may include a single server to perform operations of all servers shown in FIG. 1, the image storage 108 may be in the database 116, etc.

The camera 104 may include a high-resolution image capture device to capture detailed images of the items on the conveyance line 102. The camera 104 may capture images with a lighting device (not shown) to illuminate the items sufficiently or to ensure uniform illumination. Upon capturing an image, the camera 104 may wirelessly transmit image data to the image ingest server 110. The model prediction server 112 may perform inferencing on the received image data using deep learning and computer vision-based operations. After prediction is performed, the model prediction server 112 may transmit results to the detections queue 114. The user device 120 may receive a raw image taken by the camera 104, and overlay an indication of a defect on the image, or defect data.

The items on the conveyance line 102 may include a custom t-shirt, a custom hat, a custom jersey, etc. The items may include a product made of wood grain, cotton, rolled metal, rolled paper printing, ceramic, glass, printed circuit board (PCB), vinyl synthetic decking, another textile, or the like. The model used for prediction may be trained on one or more of these item types, such as only one, a set of types, etc.

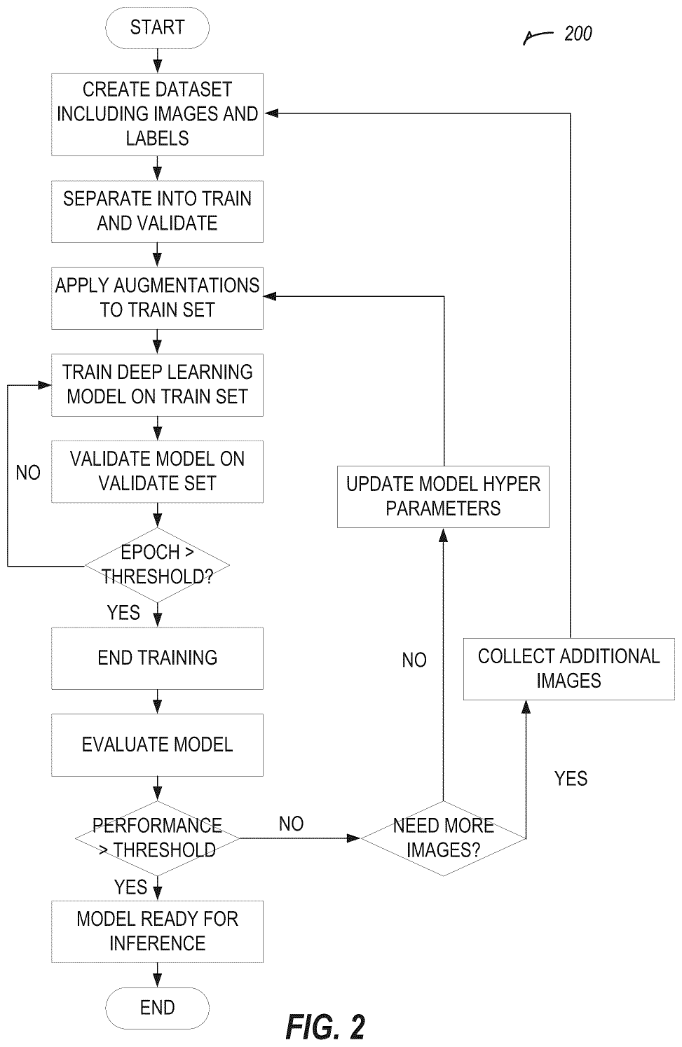

FIG. 2 illustrates a block diagram 200 showing training of a deep learning model for error detection in an image in accordance with some examples. Before using a detection model to perform inference on input images, the detection model may be trained using a dataset of images of a specific product being manufactured, a different type of product, or a combination of products. The dataset of images may include a minimum number of images of defective instances of a product, such as in a form of “.jpg” or “.png” image files and a corresponding defect annotations (e.g. a label), such as in a form of “.txt” files. The type of annotations to use, such as bounding boxes or polygons, may be determined based on a type of product, level of defect details needed, or an outcome expected, such as by an operator in a facility. In an example, polygon annotations may be used to label images including cracks on ceramic tiles or glass where defects are irregular or complex, and bounding boxes may be used for labeling missing screws on a PCB where pixel perfect precision is not needed.

To start training the model, the dataset of images may be split into two subsets (or they may have to be captured separately). The two sets of images may include a training set, such as 70% of images, and a validation set, such as 30% of images. During the training process, the model may use the training and validation sets multiple times. The training set may be used to train the model to recognize patterns belonging to each defect. The validation set may validate the ability of the model to generalize and recognize patterns. Based on performance of the model on the training set, weights of the model may be adjusted to perform better on a next pass or epoch through the training and validation sets. During training, one or more augmentation methods may be applied to some or all images to increase data diversity or improve generalization. Such augmentation methods may include horizontal or vertical flipping, rotation, resizing, cropping, grid distortion, embossing, translation, composite image creation, or the like. The process may also include optimizers commonly used in machine learning such as AdamW, Stochastic Gradient Descent (SGD), etc. At the end of each epoch or pass, the model may output relevant metrics such as a mAP (Mean Average Precision) or Recall (R) that indicate whether the model is improving in correctly recognizing different defective patterns. The training process may be stopped after a certain number of epochs, such as when the values for mAP and Recall have peaked or reached a threshold. The parameters associated with the augmentation techniques may be changed iteratively, which means that the model may be trained or retrained multiple times with different sets of augmentation parameters. A best run of the model may be chosen out of the various training or retraining attempts.

After the training stage is finished, performance of the model may be evaluated on a comprehensive and diverse test set of unseen images called a testing set of images (e.g., images the model has not seen before, such as a set of images differing from the training set and the validation set). The testing set may include a roughly even distribution of defective and non-defective product images for the model to make predictions based on the training stage. Evaluation metrics such as true positives, false positives, true negatives, or false negatives may be computed by comparing predictions of the model on the testing set of images to their respective ground-truth annotations or labels. Such metrics may assess the accuracy or reliability of the model on new and unseen data to determine whether the model is ready to be used or not. When the model is not ready, additional images may be collected for training.

When the model is sufficiently ready (e.g., one or more evaluation metrics traverse a threshold, such as 95% accurate), the trained model may be used as part of a live inference pipeline. For each captured image or an enhanced image, the model may infer whether a visual defect is present and produce bounding geometries or coordinates around all such defects. The bounding region coordinates may be transmitted to a web or mobile application where they may be overlayed on top of the captured image. The application may be accessible via any standard web browser or mobile device and may allow authorized users to view the detection results remotely in real-time.

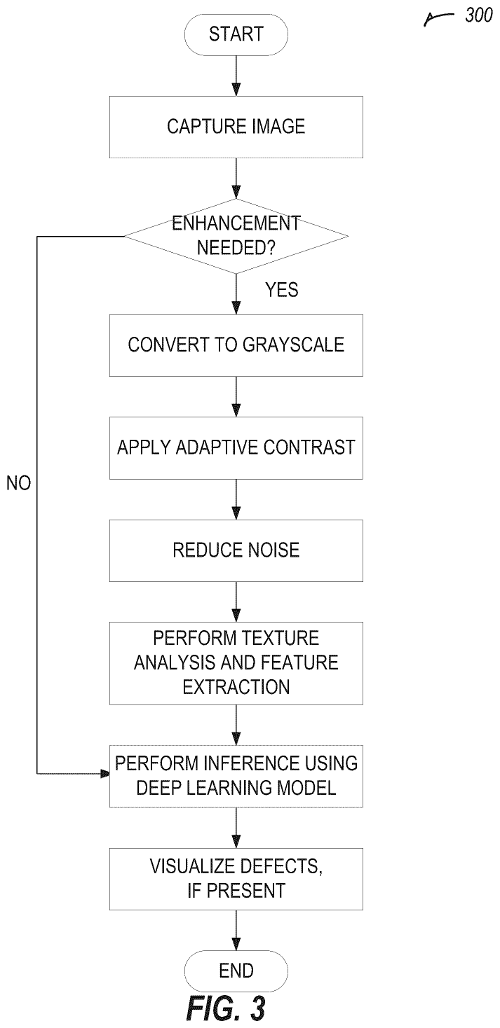

FIG. 3 illustrates a block diagram 300 showing inferencing with a deep learning model for error detection in an image in accordance with some examples. The inferencing with the deep learning model may use, as an input, a high-resolution image of each product coming out of a line captured such that the loss in detail in minimal and the product is uniformly illuminated without interference from external light. The deep learning model used for inferencing may be the model trained as described in FIG. 2 above.

In some examples, an image may be enhanced. When not needed, the image may proceed to the deep learning model for performing inferencing. When enhancement is needed, subtle details in the captured image may be enhanced using one or more computer vision techniques. Any one or more of the techniques may be applied to the image, in any order, or strictly in the order shown in FIG. 3. Whether or not enhancements are required may depend on the product itself, for example, defects such as long cracks on wood vinyl that are easily visible to the human eye may not need enhancement but extremely small and thin banding lines on a printed design may require enhancement. Banding lines may include horizontal stripes when printer ink is low. The image enhancement stage may include performing adaptive contrast adjustment, conversion to grayscale format, or noise reduction on an image. Other processing techniques may include texture analysis or feature extraction to emphasize fine-level visual discrepancies, for example, banding lines, adhesive spots, color bleeding, etcetera on a printed design in garment decoration facilities. These operations may be available as functions in certain programming languages from an open-source library, and numerical values for their parameters may be defined depending on the level of clarity needed for defects on a product. Such functions collectively serve to generate a version of the image in which potential defects are rendered more clearly visible. After enhancement or not, the deep learning model may be used on the image or enhanced image to determine whether a visual defect is present.

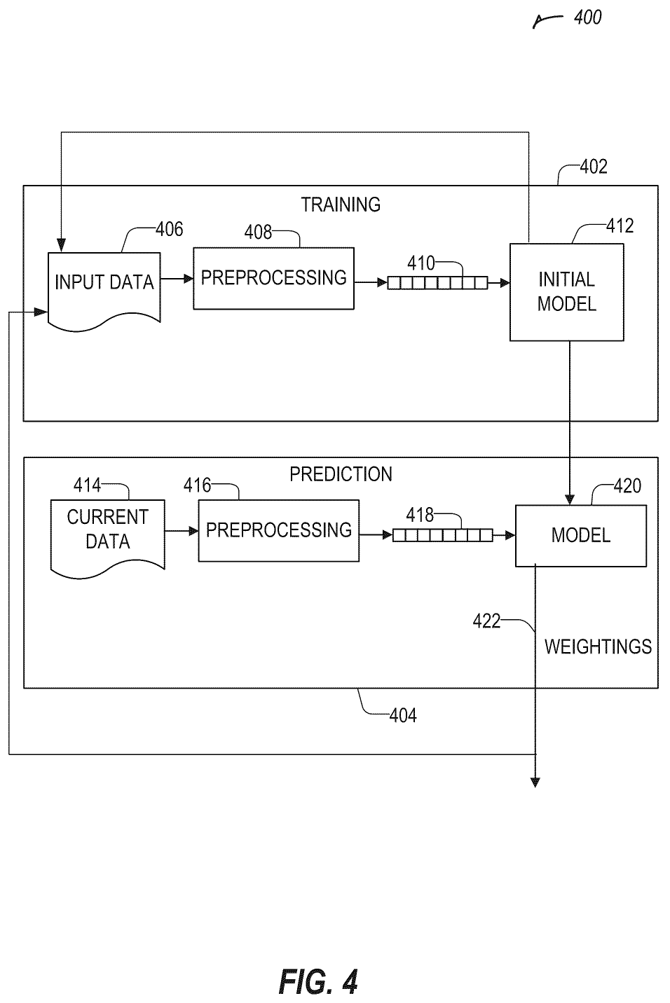

FIG. 4 illustrates a machine learning engine for training and execution related to error detection in an image in accordance with some examples. The machine learning engine may be deployed to execute at a mobile device (e.g., a cell phone, a tablet, etc.) or a computer (e.g., a desktop, a laptop, etc.). FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during unsupervised learning), for example to improve the performance of the prediction engine 404 or the initial model 412. An improved model may be redeployed for use.

The input data 406 may include a set of training images. The set of training images may represent respective products on a conveyance line, the respective products being printed on before coming off the conveyance line.

In the prediction engine 404, current data 414 (e.g., an image including a product on a conveyance line or coming off a conveyance line, or the like) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422). Labels for the input data 406 may include whether a product in an image includes a defect, a type of defect present, or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when the model converges (e.g., the model's loss function value stops decreasing significantly or past a threshold as the model is trained).

The specific machine learning algorithm used for the training engine 402 may be selected from among many different potential supervised, semi-supervised, or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a prediction, such as whether an image includes a product with a product defect. The prediction may include a type of defect, such as a defective pattern in a printed pattern, a banding line, an adhesive spot, a color bleed, or the like.

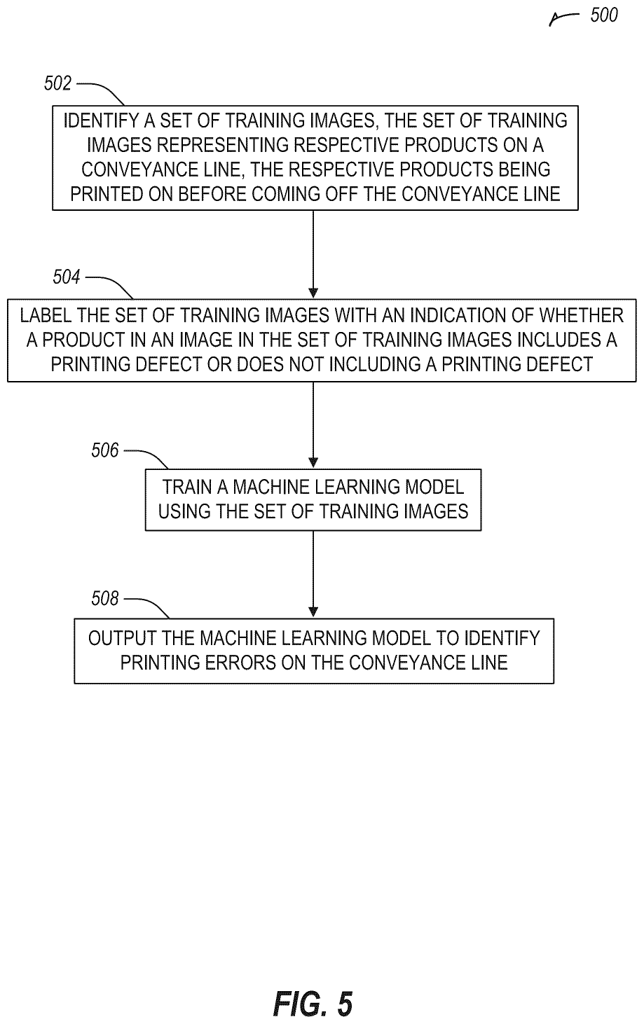

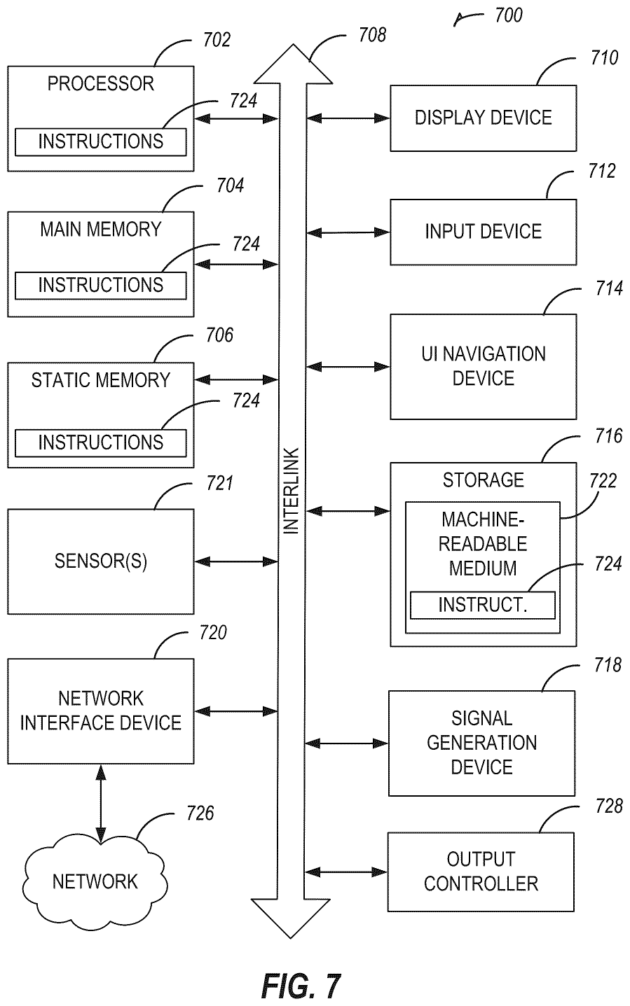

FIG. 5 illustrates a flowchart showing a technique 500 for training a deep learning model for error detection in an image in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 includes an operation 502 to identify a set of training images, the set of training images representing respective products on a conveyance line, the respective products being printed on before coming off the conveyance line. Operation 502 may include capturing the set of training images after the respective products are printed on and before the respective products come off the conveyance line.

The technique 500 includes an operation 504 to label the set of training images with an indication of whether a product in an image in the set of training images includes a printing defect or does not including a printing defect. The printing defect may include a defective pattern in a printed pattern on one or more of the respective products, a banding line on one or more of the respective products, an adhesive spot or a color bleeding on one or more of the respective products, or the like.

The technique 500 includes an operation 506 to train a machine learning model using the set of training images. The technique 500 includes an operation 508 to output the machine learning model to identify printing errors on the conveyance line.

The technique 500 may include retraining the machine learning model, such as based on performance indicated by a Mean Average Precision (mAP) or a Recall (R). The retraining may be stopped when the mAP or the Recall reach a peak or traverse a threshold. Recall (R) may indicate the ability of the model to identify all instances of one or more classes being detected by the model on the image of a product. The mAP may indicate the ability of the model to balance precision and recall across all classes being detected by the model. Retraining the model may include collecting additional images or using a different set of data augmentations to retrain the machine learning model based on determining that performance of the machine learning model falls below a threshold.

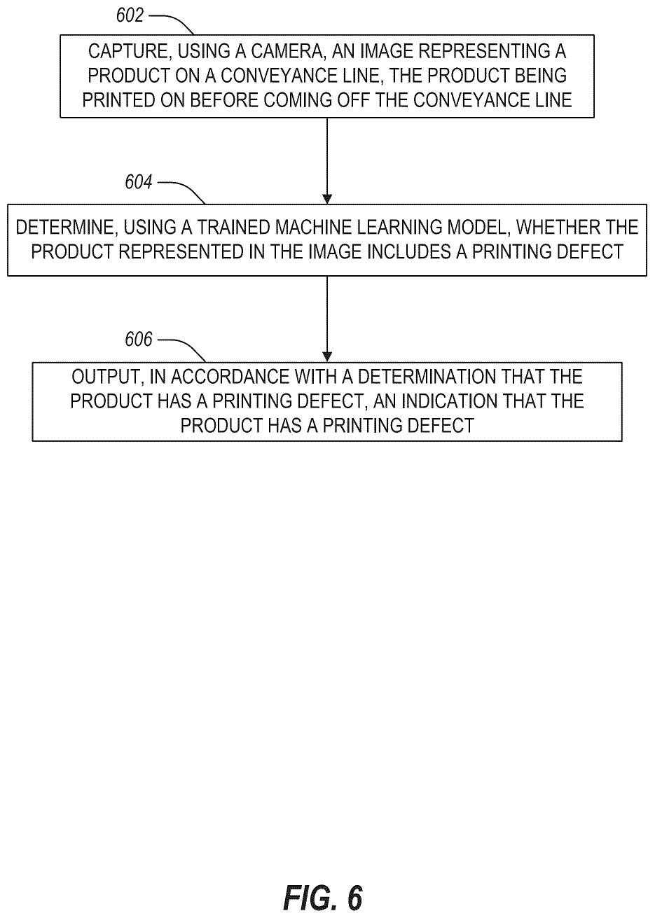

FIG. 6 illustrates a flowchart showing a technique 600 for inferencing using a deep learning model for error detection in an image in accordance with some examples. In an example, operations of the technique 600 may be performed by processing circuitry, for example by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 7.

The technique 600 includes an operation 602 to capture, using a camera, an image representing a product on a conveyance line, the product being printed on before coming off the conveyance line. The technique 600 includes an operation 604 to determine, using a trained machine learning model, whether the product represented in the image includes a printing defect. The trained machine learning model may be trained using a set of training images, the set of training images representing respective products on a second conveyance line, the respective products being printed on before coming off the second conveyance line. The products printed on in the second conveyance line may be made of a different medium than the product (e.g., wood, cotton, metal, ceramic, etc.).

The technique 600 includes an operation 606 to output, in accordance with a determination that the product has a printing defect, an indication that the product has a printing defect. The technique 600 may include an operation to, before determining, using the trained machine learning model, whether the product represented in the image includes the printing defect, determining whether an enhancement to the image is needed. This operation may include, when the enhancement to the image is needed, converting the image to grayscale, applying an adaptive contrast adjustment to the image, or reducing noise in the image. In this example, determining, using the trained machine learning model, whether the product represented in the image includes the printing defect may include performing a texture analysis and feature extraction on the image.

FIG. 7 illustrates generally an example of a block diagram of a machine upon which any one or more of the techniques discussed herein may perform, according to various examples. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

The following, non-limiting examples, detail certain aspects of the present subject matter to solve the challenges and provide the benefits discussed herein, among others.

Example 1 is a non-transitory machine-readable medium including instructions, which when executed by processing circuitry, cause the processing circuitry to perform operations comprising: identifying a set of training images, the set of training images representing respective products on a conveyance line, the respective products being printed on before coming off the conveyance line; labeling the set of training images with an indication of whether a product in an image in the set of training images includes, a printing defect or does not including a printing defect; training a machine learning model using the set of training images; and outputting the machine learning model to identify printing errors on the conveyance line.

In Example 2, the subject matter of Example 1 includes, wherein identifying the set of training images includes capturing the set of training images after the respective products are printed on and before the respective products come off the conveyance line.

In Example 3, the subject matter of Examples 1-2 includes, wherein the printing defect is a defective pattern in a printed pattern on one or more of the respective products.

In Example 4, the subject matter of Examples 1-3 includes, wherein the printing defect is a banding line on one or more of the respective products.

In Example 5, the subject matter of Examples 1-4 includes, wherein the printing defect is an adhesive spot or a color bleeding on one or more of the respective products.

In Example 6, the subject matter of Examples 1-5 includes, retraining the machine learning model based on a Mean Average Precision (mAP) and a recall (R).

In Example 7, the subject matter of Example 6 includes, stopping retraining of the machine learning model when the mAP or the recall reach a peak or traverse a threshold.

In Example 8, the subject matter of Examples 6-7 includes, wherein the mAP indicates an ability of the model to balance precision and recall across classes detected by the model.

In Example 9, the subject matter of Example 6 includes, wherein the Recall (R) indicates an ability of the model to identify instances of one or more classes detected by the machine learning model.

In Example 10, the subject matter of Examples 6-9 includes, collecting additional images to retrain the machine learning model based on determining that performance of the machine learning model falls below a threshold.

Example 11 is a non-transitory machine-readable medium including instructions, which when executed by processing circuitry, cause the processing circuitry to perform operations comprising: capturing, using a camera, an image representing a product on a conveyance line, the product being printed on before coming off the conveyance line; determining, using a trained machine learning model, whether the product represented in the image includes, a printing defect; and outputting, in accordance with a determination that the product has a printing defect, an indication that the product has a printing defect.

In Example 12, the subject matter of Example 11 includes, wherein the trained machine learning model is trained using a set of training images, the set of training images representing respective products on a second conveyance line, the respective products being printed on before coming off the second conveyance line.

In Example 13, the subject matter of Example 12 includes, wherein products printed on in the second conveyance line are made of a different medium than the product.

In Example 14, the subject matter of Examples 11-13 includes, before determining, using the trained machine learning model, whether the product represented in the image includes the printing defect, determining whether an enhancement to the image is needed.

In Example 15, the subject matter of Example 14 includes, wherein the enhancement to the image is needed, and wherein the enhancement includes converting the image to grayscale.

In Example 16, the subject matter of Examples 14-15 includes, wherein the enhancement to the image is needed, and wherein the enhancement includes applying an adaptive contrast adjustment to the image.

In Example 17, the subject matter of Examples 14-16 includes, wherein the enhancement to the image is needed, and wherein the enhancement includes reducing noise in the image.

In Example 18, the subject matter of Examples 14-17 includes, wherein determining, using the trained machine learning model, whether the product represented in the image includes the printing defect includes performing a texture analysis and feature extraction on the image.

Example 19 is a system comprising: a camera configured to capture a set of training images, the set of training images representing respective products on a conveyance line, the respective products being printed on before coming off the conveyance line; processing circuitry; and memory, including instructions, which when executed by the processing circuitry, cause the processing circuitry to perform operations comprising: labeling the set of training images with an indication of whether a product in an image in the set of training images includes, a printing defect or does not including a printing defect; training a machine learning model using the set of training images; and outputting the machine learning model to identify printing errors on the conveyance line.

In Example 20, the subject matter of Example 19 includes, wherein the printing defect is a defective pattern in a printed pattern on one or more of the respective products, or a banding line, an adhesive spot, or a color bleeding on one or more of the respective products.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A non-transitory machine-readable medium including instructions, which when executed by processing circuitry, cause the processing circuitry to perform operations comprising:
identifying a set of training images, the set of training images representing respective products on a conveyance line, the respective products being printed on before coming off the conveyance line;
labeling the set of training images with an indication of whether a product in an image in the set of training images includes a printing defect or does not including a printing defect;
training a machine learning model using the set of training images; and
outputting the machine learning model to identify printing errors on the conveyance line.

2. The non-transitory machine-readable medium of claim 1, wherein identifying the set of training images includes capturing the set of training images after the respective products are printed on and before the respective products come off the conveyance line.

3. The non-transitory machine-readable medium of claim 1, wherein the printing defect is a defective pattern in a printed pattern on one or more of the respective products.

4. The non-transitory machine-readable medium of claim 1, wherein the printing defect is a banding line on one or more of the respective products.

5. The non-transitory machine-readable medium of claim 1, wherein the printing defect is an adhesive spot or a color bleeding on one or more of the respective products.

6. The non-transitory machine-readable medium of claim 1, further comprising retraining the machine learning model based on a Mean Average Precision (mAP) and a recall (R).

7. The non-transitory machine-readable medium of claim 6, further comprising stopping retraining of the machine learning model when the mAP or the recall reach a peak or traverse a threshold.

8. The non-transitory machine-readable medium of claim 6, wherein the mAP indicates an ability of the model to balance precision and recall across classes detected by the model.

9. The non-transitory machine-readable medium of claim 6, wherein the Recall (R) indicates an ability of the model to identify instances of one or more classes detected by the machine learning model.

10. The non-transitory machine-readable medium of claim 6, further comprising collecting additional images to retrain the machine learning model based on determining that performance of the machine learning model falls below a threshold.

11. A non-transitory machine-readable medium including instructions, which when executed by processing circuitry, cause the processing circuitry to perform operations comprising:
capturing, using a camera, an image representing a product on a conveyance line, the product being printed on before coming off the conveyance line;
determining, using a trained machine learning model, whether the product represented in the image includes a printing defect; and
outputting, in accordance with a determination that the product has a printing defect, an indication that the product has a printing defect.

12. The non-transitory machine-readable medium of claim 11, wherein the trained machine learning model is trained using a set of training images, the set of training images representing respective products on a second conveyance line, the respective products being printed on before coming off the second conveyance line.

13. The non-transitory machine-readable medium of claim 12, wherein products printed on in the second conveyance line are made of a different medium than the product.

14. The non-transitory machine-readable medium of claim 11, further comprising, before determining, using the trained machine learning model, whether the product represented in the image includes the printing defect, determining whether an enhancement to the image is needed.

15. The non-transitory machine-readable medium of claim 14, wherein the enhancement to the image is needed, and wherein the enhancement includes converting the image to grayscale.

16. The non-transitory machine-readable medium of claim 14, wherein the enhancement to the image is needed, and wherein the enhancement includes applying an adaptive contrast adjustment to the image.

17. The non-transitory machine-readable medium of claim 14, wherein the enhancement to the image is needed, and wherein the enhancement includes reducing noise in the image.

18. The non-transitory machine-readable medium of claim 14, wherein determining, using the trained machine learning model, whether the product represented in the image includes the printing defect includes performing a texture analysis and feature extraction on the image.

19. A system comprising:
a camera configured to capture a set of training images, the set of training images representing respective products on a conveyance line, the respective products being printed on before coming off the conveyance line;
processing circuitry; and
memory, including instructions, which when executed by the processing circuitry, cause the processing circuitry to perform operations comprising:
labeling the set of training images with an indication of whether a product in an image in the set of training images includes a printing defect or does not including a printing defect;
training a machine learning model using the set of training images; and
outputting the machine learning model to identify printing errors on the conveyance line.

20. The system of claim 19, wherein the printing defect is a defective pattern in a printed pattern on one or more of the respective products, or a banding line, an adhesive spot, or a color bleeding on one or more of the respective products.
